(19) United States
(12) Patent Application Publication
(10) Pub. No.: US 2022/0105856 A1
(43) Pub. Date: Apr. 7, 2022

(54) SYSTEM AND METHOD FOR DETERMINING A LATERAL OFFSET OF A SWAP BODY IN RELATION TO A VEHICLE

(71) Applicant: ZF Friedrichshafen AG, Friedrichshafen (DE)

(72) Inventors: Patrick Kniess, Aulendorf (DE); Thomas Jäger, Meckenbeuren (DE); Alexander Häfele, Wangen (DE); Basem Abdo, Friedrichshafen (DE); Alexander Banerjee, Oberteuringen (DE)

(73) Assignee: ZF Friedrichshafen AG, Friedrichshafen (DE)

(21) Appl. No.: 17/255,563

(22) PCT Filed: May 27, 2019
(86) PCT No.: PCT/EP2019/063585

§ 371 Date: Dec. 8, 2021

(30) Foreign Application Priority Data
Jun. 26, 2018 (DE) 10 2018 210 346.1

(51) Int. Cl. B60P 1/64; B62D 15/02; G01S 17/08; G01S 17/88

(52) U.S. Cl. CPC B60P 1/649; G01S 17/88; G01S 17/08; B62D 15/0285

(57) ABSTRACT

The invention discloses a system and a method for determining a lateral offset of a swap body in relation to a vehicle while aligning the vehicle under the swap body. Crossed pairs of distance sensors are used, which detect distances to the vertical surfaces on guide elements on the swap body to determine a lateral offset of the swap body in relation to the vehicle. The detected distances are evaluated by a signal processing device.

### TECHNICAL FIELD

The present invention relates to a system and a method for determining a lateral offset of a swap body in relation to a vehicle. In particular, the invention relates to a system and a method for assisting in aligning a vehicle under a swap body, in order to simplify the receiving thereof.

### PRIOR ART

There are systems known from the prior art for assisting in aligning vehicles intended for accommodating swap bodies underneath swap bodies. By way of example, DE 10 2006 057 610 A1 discloses a system in which a vehicle is assisted in aligning a vehicle under a swap body by imaging sensors. Distances between the vehicle and the swap body can be determined with this system, such that it can effectively intervene in the receiving process.

### SUMMARY OF THE INVENTION

The present invention relates to a system for determining a lateral offset of a swap body in relation to a vehicle while the vehicle is being aligned under the swap body. The system has at least two distance sensors, which can be placed on the vehicle, each of which is configured to determine a distance from the vehicle to predefined measurement points on the swap body and output a corresponding signal.

Each distance sensor can emit a measurement beam for measuring the distance, which is oriented in relation to a vertical longitudinal plane through the vehicle such that it converges on the vertical longitudinal plane starting from the respective distance sensor. In other words, the distance sensors are arranged such that the respective measurement beams are angled toward the vertical longitudinal plane.

The system also has a signal processing device that is configured to determine a lateral offset of the swap body to the vehicle based on the signals output by the at least two distance sensors, and output a corresponding output signal. Two of the at least two distance sensors can be placed at substantially the same longitudinal position on the vehicle. In other words, the distance sensors can be mounted on the vehicle as a pair, such that the distance sensors in a pair are spaced apart laterally on the vehicle. By way of example, there can be two such pairs of distance sensors, wherein the two sensor pairs are spaced apart in the longitudinal direction of the vehicle. It should be noted that the number of sensors is not limited to the number given above. There can be numerous other sensors or sensor pairs.

Two of the at least two distance sensors can be placed symmetrically in relation to the vertical longitudinal plane through the vehicle. In other words, the two distance sensors in a pair can lie at the same lateral distance to the vertical longitudinal plane through the vehicle.

The measurement beams of the distance sensors can be oriented such that they pass by, or cross one another, before reaching the respective measurement points. The measurement beams of the individual sensor pairs are therefore aligned such that they initially converge.

The measurement beams can be oriented such that they do not pass by one another or cross before reaching the respective measurement points.

The at least two distance sensors can be arranged such that the directions of the measurement beams have an upward vertical component. Measurement points can be obtained in this manner that are vertically distanced from the distance sensors.

The at least two distance sensors can be arranged such that the directions of the measurement beams have a longitudinal component toward the rear of the vehicle. Measurement points can be obtained in this manner that are offset to the positions of the distance sensors in the longitudinal direction of the vehicle. Measurement points on the swap body can then be detected when the vehicle is not yet beneath the swap body.

At least two of the distance sensors can be arranged such that the directions of the measurement beams have a lateral component in relation to the vehicle. The measurement beams can therefore be directed at an angle to the vertical longitudinal plane through the vehicle. Measurement points can be reached with the measurement beams in this manner that are located on vertical surfaces on the swap body.

Two of the at least two distance sensors can be placed toward the rear of the vehicle, seen in the longitudinal direction of the vehicle. Two of the at least two distance sensors can be placed toward the front of the vehicle. The distance sensors can be laser sensors.

Two of the at least two distance sensors can be spaced apart from one another in the longitudinal direction of the vehicle, and the system can be configured to store reference distances for the respective distance sensors based on measured distances when the swap body is on the vehicle, or when the swap body is correctly positioned and oriented above a vehicle, and determine a lateral offset and/or orientation of the swap body in relation to the vehicle in a subsequent loading of the swap body, based on a comparison of the stored reference distances with the actual distances detected by the distance sensors, and output a corresponding output signal.

The at least two distance sensors can be placed at the same distance to the vertical longitudinal plane through the vehicle.

The at least two distance sensors can be arranged such that the directions of the measurement beams can have an upward vertical component.

At least one of the at least two distance sensors can be arranged such that the direction of the measurement beam has a longitudinal component toward the rear of the vehicle.

The at least two distance sensors can be arranged such that the directions of their measurement beams have a lateral component in relation to the vehicle.

Each measurement point can be located on a guide assembly located on the undersurface of the swap body. The guide assembly can comprise two guide rails, and the measurement points can be located on an inner surface or outer surface of the guide rails. The inner surfaces of the guide rails and the outer surfaces of the guide rails can be formed, e.g. by vertical surfaces.

The system can also contain a longitudinal distance sensor directed horizontally toward the rear, which is configured to determine a distance between the vehicle and the swap body in the longitudinal direction of the vehicle. This longitudinal distance sensor can be mounted on the vehicle in the longitudinal direction thereof, and connected to the signal processing device. The signal processing device can be configured to output signals for assisting in the alignment process based on the distances measured by the distance sensors and the longitudinal distance sensor.

The invention also relates to a vehicle for accommodating a swap body. The vehicle can have a receiving structure for accommodating the swap body. The vehicle can also have a system such as that described above, in which the distance sensors are arranged on the receiving structure. The height of the receiving structure can be adjustable. Distance sensors can be aligned in this manner in relation to the guide assembly on the swap body.

The vehicle can have a control unit for autonomous operation, which at least enables autonomous operation while receiving the swap body. The control unit can be sent the output signal from the signal processing device for this autonomous operation.

Two of the at least two distance sensors can be placed on the vehicle in the rear, seen in the longitudinal direction thereof. Furthermore, two more of the at least two distance sensors can be placed on of the vehicle toward the front. The signal processing device can be configured to determine an orientation of the swap body on the basis of the distances that are detected when both the distance sensors in the rear of the vehicle as well as the distance sensors toward the front of the vehicle have detected distances, in particular to the guide assembly on the swap body. In addition to determining the lateral offset of the swap body, it is also possible to determine an orientation of the swap body when two sensor pairs that are offset to one another in the longitudinal direction of the vehicle detect distances to the guide assembly on the swap body.

The control unit for the autonomous operation and the signal processing device can be separate units. Means can be provided enabling communication between the control unit and the signal processing unit. It is also possible for the control unit for autonomous operation and the signal processing device to be formed integrally. It is also possible to integrate the signal processing device and the control unit for autonomous operation in a higher order control system configured to control the vehicle.

The invention also relates to a method for determining a lateral offset of a swap body in relation to a vehicle while aligning the vehicle under the swap body. The method can be executed with a system or a vehicle that has one or more features of the system described above.

The method can comprise a step for determining the distance between a vehicle and predetermined measurement points on the swap body with at least two distance sensors mounted on the vehicle, wherein each distance sensor emits a measurement beam for measuring the distance, which is oriented in relation to a vertical longitudinal axis through the vehicle such that it converges on the vertical longitudinal axis starting from the respective distance sensor. Furthermore, the method can comprise a step for determining the lateral offset of the swap body in relation to the vehicle, based on the signals output by the at least two distance sensors.

The method can also comprise a step for positioning the at least two distance sensors such that they are directed toward predetermined measurement points on the swap body when aligning the vehicle. The predetermined measurement points can be located at substantially half the height of an inner surface or an outer surface of the guide rails in a guide channel on the swap body.

At least two distance sensors can be aligned such that the predetermined measurement points can then be detected when the vehicle is still in front of the swap body in the longitudinal direction thereof.

The method can also comprise a step for determining a distance between the vehicle and the swap body in the longitudinal direction of the vehicle using a longitudinal distance sensor. The determination of the lateral offset can take place taking the distance output by the longitudinal distance sensor into account.

The lateral offset can also be determined using a GPS heading, in order to clear an angular position of the vehicle from the lateral offset.

The method can also comprise a calibration step for calibrating two distance sensors spaced apart in the longitudinal direction of the vehicle. Reference distances are stored for the respective distance sensors in the calibration step based on the measured distances to a swap body correctly loaded onto the vehicle, or when the swap body is correctly positioned and oriented above a vehicle.

The calibration step can take place automatically when a swap body has been loaded onto a vehicle, or a vehicle has been driven underneath it.

The step for determining the lateral offset of the swap body in relation to the vehicle can take place on the basis of a comparison of the stored reference distances with the actual distances detected by the distance sensors when aligning the vehicle.

Overall, a system and a method can be created with which a position and/or orientation, in particular a lateral offset, of the swap body can be determined by using two sensors that are offset in the longitudinal direction of the vehicle. This requires that the distance from the vehicle to the swap body is determined from the absolute measurement signals from the sensors. The calibration described above can be implemented for this. When the swap body has been loaded onto the vehicle, the distance measured by the sensors can be stored. This distance is then the reference distance for further loading procedures. Such a system can be implemented in combination with the aforementioned system, or it can be implemented as an independent system. The detection using two sensors spaced apart in the longitudinal direction of the vehicle can be used to increase the overall measurement precision in a system with four distance sensors. Furthermore, the system is more reliable, because if one sensor in a pair of laterally spaced apart distance sensors malfunctions, it is possible to switch over to a detection with two distance sensors spaced apart longitudinally.

The calibration can take place as follows: It is first detected whether the swap body is loaded onto the vehicle. This can be detected, e.g. by a corresponding actuation by the driver, e.g. by pushing a button. Alternatively or additionally, the level of the receiving structure, or a height-adjustable chassis, can be detected in order to determine whether the level corresponds to that when a swap body is loaded thereon. If the receiving structure is raised as high as possible, this can be regarded as the state in which the swap body is loaded onto the vehicle. The detection of a measurement object on the vehicle in conjunction with a vehicle speed that is higher than a predetermined minimum speed can be regarded as an indication of a state in which a swap body is correctly received on the vehicle. If it is detected that the swap body is loaded onto the vehicle, the distances detected by the distance sensors are then stored as reference positions for a correctly loaded swap body. These reference positions or stored distances can then be used for the target positions or target distances for loading the swap body.

The calibration or calibration process can be used on each distance sensor. Data referring to the stored distances can be stored in the control unit or a memory intended for this, and drawn on for the next loading procedure with the vehicle.

It should be noted that the aforementioned data can also be obtained in an unloading procedure, e.g. when the swap body is supported on legs, and the vehicle drives slowly out from under the swap body. Such an unloading procedure can be detected based on the axle load to the vehicle. The axle load decreases when the swap body is supported on its legs. An axle load sensor can be used for detecting the axle load.

### BRIEF DESCRIPTION OF THE DRAWINGS

FIG. 1 shows a schematic top view of a vehicle and a swap body, on which the concept according to the invention can be implemented;

FIG. 2 shows a schematic illustration of the vehicle and the swap body in the longitudinal direction;

FIG. 3 shows a schematic top view of another vehicle and another swap body, on which the concept according to the invention can be implemented;

FIG. 4 shows a schematic illustration of part of the vehicle and the swap body, seen in the longitudinal direction; and

FIG. 5 shows, schematically, the steps of the method during an alignment of the vehicle under the swap body.

### DESCRIPTION OF EMBODIMENTS

Embodiments of the invention shall be described in reference to the drawings below. It should be noted that the same reference symbols are used to indicate the same or similar elements in the various figures.

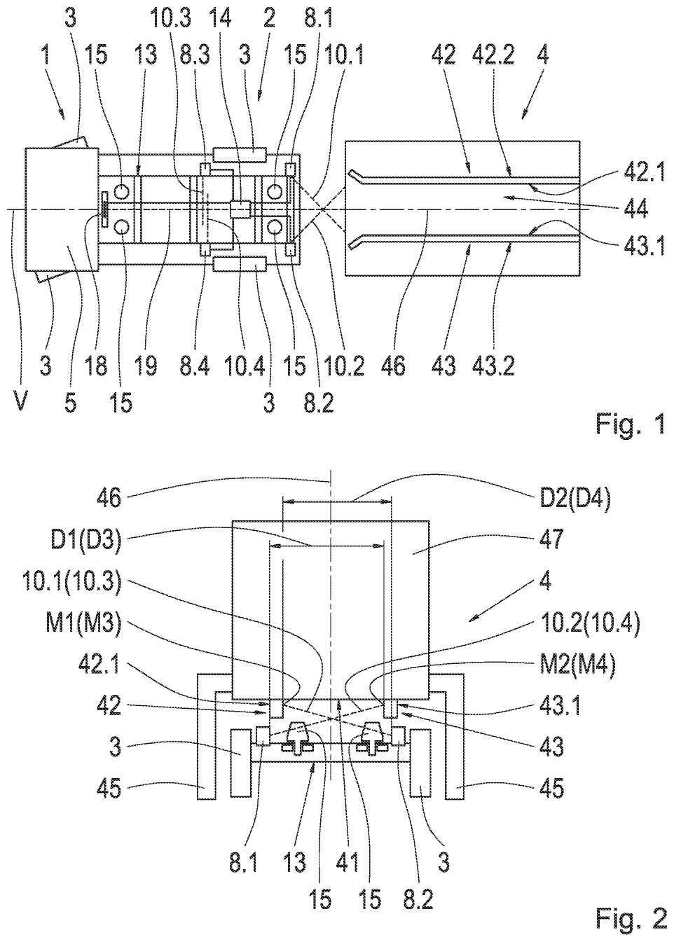

FIG. 1 shows a vehicle 1 designed for accommodating swap bodies 4. FIG. 1 also shows a swap body 4 that is to be accommodated on the vehicle 1. The vehicle has a driver's cab 5 at the front and a receiving structure 13 at the rear. In the drawing, the vehicle has one front axle and two rear axles, on which wheels 3 are provided. Different configurations are also conceivable. The vehicle also does not necessarily have to have a driver's cab 5, in particular if the vehicle is an autonomously operated vehicle.

The swap body 4 is parked behind the vehicle 1 in the longitudinal direction in FIG. 1. The swap body 4 is received by driving the vehicle 1 under the swap body 2.

FIG. 1 shows a schematic top view of the arrangement of guide elements 15 on the receiving structure 13 on the vehicle 1. In particular, two guide elements 15 are attached to the vehicle 1 at the rear, which are spaced laterally apart on the vehicle. Guide elements 15 are shown at the front of the receiving structure 13 that are likewise spaced laterally apart on the vehicle. The guide elements are guide rollers in this embodiment. The guide elements 15 mounted at the rear of the receiving structure 13 form a first pair of guide elements. The guide elements 15 mounted at the front of the receiving structure 13 form a second pair of guide elements. The first pair of guide elements 15 is spaced longitudinally apart from the second pair of guide elements 15. There are therefore four guide elements 15 on the receiving structure 13 in this embodiment, which are mounted at each of the four corners of an imaginary rectangle.

In the present embodiment, the guide elements or guide rollers are each mounted on the receiving structure 13 on the vehicle 1 such that they can rotate about an axis that is substantially vertical, or directed upward. The rollers are also conical in the present invention, such that the diameter of the guide rollers is greater at the bottom than at the top.

There is also a system 2 on the vehicle 1 or its receiving structure 13 for detecting a lateral offset of the swap body 4 shown in FIG. 1 to the vehicle 1. The system 2 contains four distance sensors 8.1, 8.2, 8.3, 8.4. The distance sensors 8.1, 8.2, 8.3, 8.4 are arranged in pairs. The distance sensors 8.1, 8.2 form a first, rear distance sensor pair, and the distance sensors 8.3, 8.4 form a front, second pair of distance sensors. The distance sensors in pairs are spaced apart laterally on the vehicle 1. More precisely, the distance sensors are arranged symmetrically to a vertical longitudinal plane V in this embodiment, and spaced apart from one another longitudinally.

The distance sensors are laser sensors in the present embodiment. The distance sensors 8.1, 8.2, 8.3, 8.4 emit measurement beams 10.3, 10.4, that are oriented in relation to a vertical longitudinal plane V through the vehicle such that they converge on the vertical longitudinal plane starting from the respective distance sensors. In other words, the distance sensors are arranged such that the respective measurement beams are angled toward the vertical longitudinal plane V. In the present embodiment, the measurement beams from the distance sensors cross. The measurement beams from the rear distance sensors are pointed diagonally toward the rear and diagonally upward. In this manner, it is possible to detect a guide assembly on the swap body 4 early, in particular before the vehicle 1 reaches the swap body 4. The measurement beams from the front distance sensors are pointed diagonally upward, such that each measurement beam from the front distance sensors runs in a plane that is substantially perpendicular to the vertical longitudinal plane V.

The structure of the swap body 4 can also be seen in FIGS. 1 and 2. The swap body 4 is substantially a container 47, which is supported on legs 45 in FIGS. 1 and 2. The legs support the swap body 4, and are at a lateral distance to a central plane 46 through the swap body 4, such that they are arranged substantially symmetrically. The legs 45 can support the swap body 4, and after the swap body 4 has been received on the vehicle, they can be disengaged and pivoted upward. The legs 45 can also be displaced laterally and/or height-adjustable. A guide channel 44 is formed on an undersurface or bottom 41 of the swap body 4, which is formed by laterally spaced apart guide elements or guide rails 42, 43, which extend in the longitudinal direction of the swap body 4 and are are mounted permanently to the undersurface of the swap body 4. The guide rails 42, 43 have inner surface 42.1, 43.1 that face one another, and two outer surfaces 42.2, 43.2 facing away from one another.

The vehicle 1 also has a signal processing device 14 connected to the distance sensors 8.1, 8.2, 8.3, 8.4. A longitudinal distance sensor 18 is also mounted on the back of the driver's cab 5, which emits a horizontal measurement beam toward the rear in the longitudinal direction, for determining a distance between the vehicle 1 and the swap body 4 in the longitudinal direction of the vehicle 1. This distance sensor 18 is also connected to the signal processing device 14.

The vehicle has a height-adjustable chassis. For the system 2 to be able to make a correct measurement, the receiving structure 13 is moved vertically such that the measurement beams of the distance sensors strike the inner surfaces 42.1, 43.1 of the guide rails 42, 43 at predetermined measurement points M1, M2, M3, M4, which are located at about half the height of the guide rails. Once the vehicle 1 is at the right height, the sensor pairs can detect a distance to the respective measurement points, and the signal processing device 14 can calculate a lateral offset of the swap body 4 to the vehicle 1 from the detected distances. Because the measurement beams of the rear distance sensor pair are directed diagonally upward, the lateral offset can already be determined in the state shown in FIG. 1, in which the vehicle is positioned in front of the swap body 4 at a distance thereto.

The fundamental sequence for aligning the vehicle 1 under the swap body 4 shall be described next. The vehicle 1 is first positioned longitudinally in front of the swap body 4, as shown in FIG. 1. The vehicle 1 should be aligned longitudinally as precisely as possible with the swap body 4. The vehicle 1 is then driven under the swap body 4, in order to receive it. At this point, a lateral offset of the swap body 4 in relation to the vehicle 1 is first determined by the rear pair of distance sensors 8.1, 8.2. If a lateral offset is detected, it can be counteracted using the steering wheel to redirect the vehicle.

The vehicle 1 is moved toward the swap body 4 taking the distances detected by the distance sensors 8.1, 8.2 into account. At this point, the distance sensors 8.1, 8.2 are first moved under the swap body 4, and the rear guide elements 15 are subsequently moved under the swap body 4. When driving the vehicle 1 under the swap body 4, a lateral offset of the swap body 4 to the vehicle 1 is continuously determined in the signal processing device 14 using the distance sensors 8.1, 8.2, and then output, if necessary, to a control unit to trigger a redirection of the vehicle. As the vehicle 1 continues to drive under the swap body 4, the front pair of distance sensors 8.3, 8.4 end up underneath the swap body 4, or its guide channel 44. The measurement beams 10.3, 10.4 from the distance sensors 8.3, 8.4 then also strike the inner surfaces 42.1, 43.1 of the guide rails 42, 43. A lateral offset of the swap body 4 to the vehicle 1 can also be detected with this front sensor pair. As the vehicle 1 continues to drive under the swap body 4, the front pair of guide elements 15 also ends up under the guide channel 44 on the swap body 4. When everything functions optimally, a lateral offset of the swap body 4 can be reliably detected with the system, and eliminated by steering the vehicle 1 appropriately, such that the guide elements 15 are positioned optimally underneath the guide channel 44, or laterally between the guide rails 42, 43. The swap body 4 can then be received on the vehicle 1, or its receiving structure 13.

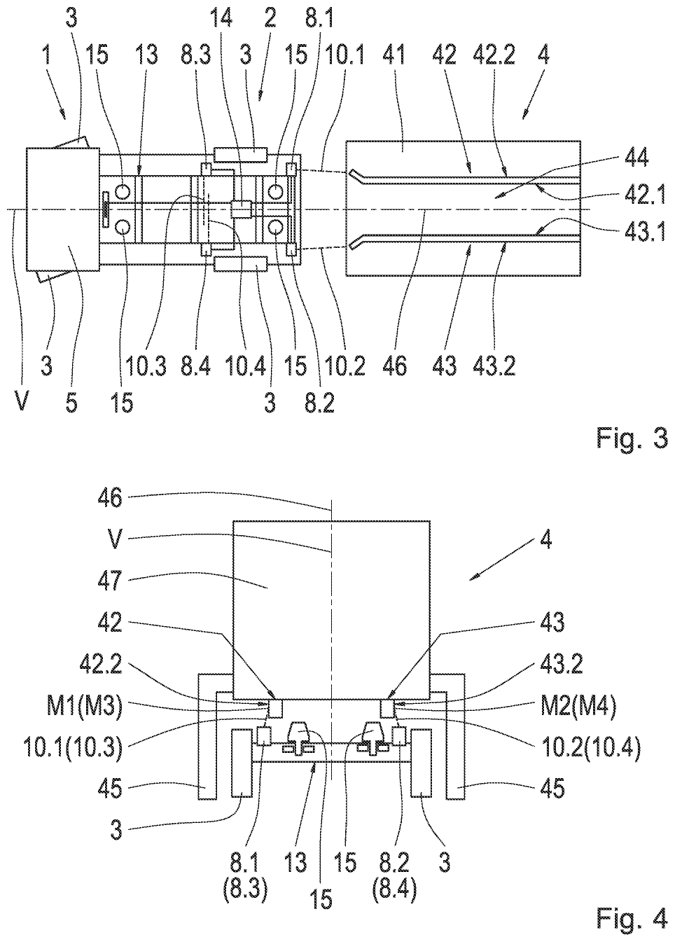

Another embodiment or modification of the embodiments described in reference to FIGS. 1 and 2 shall be described in reference to FIGS. 3 and 4. The structure of the vehicle 1 shown in FIGS. 3 and 4 differs from that shown in FIGS. 1 and 2 only in terms of the orientation of the measurement beams 10.1, 10.2, 10.3, 10.4, and the swap body 4 differs from that shown in FIGS. 1 and 2 only in that the guide channel 44 is narrower, i.e. the guide rails 42, 43 are closer together laterally. In contrast to the embodiments shown in FIGS. 1 and 2, measurement points M1, M2, M3, M4 on the outer surfaces 42.2, 43.2 of the guide rails 42, 43 are detected with the distance sensors 8.1, 8.2, 8.3, 8.4. Aside from this, the principle and manner of functioning of the modified embodiments are identical to that of the embodiments shown in FIGS. 1 and 2.

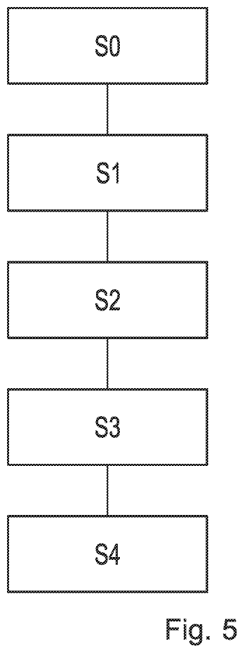

The method used for the alignment is shown schematically in FIG. 5. The four distance sensors 8.1, 8.2, 8.3, 8.4 are first positioned in step S1 by the actuation of the height-adjustable chassis described above, such that they are directed at the measurement points M1, M2, M3, M4 on the swap body when the vehicle 1 is aligned with the swap body. The measurement points M1, M2, M3, M4 are located on the inner surfaces 42.1, 43.1 or outer surfaces 42.2, 43.2 of the guide rails 42, 43 in the guide channel 44 at substantially half the height thereof. After positioning the vehicle in step S1, a distance D1, D2, D3, D4 of the vehicle to the measurement points M1, M2, M3, M4 on the swap body 4 can be determined with the distance sensors 8.1, 8.2, 8.3, 8.4 mounted on the vehicle 1. Each of the distance sensors 8.1, 8.2, 8.3, 8.4 emits a measurement beam 10.1, 10.2, 10.3, 10.4 for measuring the distances D1, D2, D3, D4, which is oriented in relation to a vertical longitudinal plane V through the vehicle such that it converges on the vertical longitudinal plane starting from the respective distance sensor.

The lateral offset of the swap body 4 to the vehicle 1 is then determined in step S4 on the basis of the signals output by the distance sensors. This lateral offset can then be sent to a higher order control device, which actively controls the steering of the vehicle 1.

During the alignment, a distance between the vehicle 1 and the swap body 4 can also be detected in the longitudinal direction of the vehicle 1 with the longitudinal distance sensor 18 in step S3. The lateral offset in step 4 can then be determined in step S4 taking the distance output by the longitudinal distance sensor 18 into account. A lateral offset can also be determined in step S4 using a GPS heading, wherein this lateral offset does not indicate an angle of the vehicle.

Although it is not explicitly shown in the drawings, the system 2 can be configured according to another embodiment to use two distance sensors 8.1, 8.2 spaced apart in the longitudinal direction of the vehicle 1 to determine an lateral offset and/or orientation of the swap body 4 to the vehicle 1. According to this other embodiment, the system is configured to store reference distances for the respective distance sensors 8.1, 8.3 based on the distances D1, D3 measured when the swap body 4 is on the vehicle 1, or when the swap body 4 is correctly positioned and oriented above a vehicle 1. These stored reference distances are then used in a subsequent loading procedure for the swap body 4 to determine a lateral offset of the swap body 4 to the vehicle based on a comparison of the stored reference distances with the actual distances detected by the distance sensors 8.1, 8.3, and to output a corresponding output signal. Such a system can comprise the structure of a system such as that described in reference to FIGS. 1 to 4. If the system is implemented as an independent alternative system, one of the sensors in the pairs of distance sensors spaced apart in the longitudinal direction of the vehicle can be eliminated in the systems described in reference to FIGS. 1 to 4.

The above system according to the second embodiment makes use of a calibration process, which is specified in FIG. 5 as step S0. Two distance sensors spaced apart in the longitudinal direction of the vehicle are calibrated in the calibration step S0. Reference distances for the respective distance sensors are stored in this calibration step based on measured distances to a swap body 4 correctly loaded onto a vehicle 1, or to a swap body correctly positioned and oriented over to a vehicle.

The calibration step can be automated when a swap body is correctly loaded or a vehicle is positioned properly underneath it.

The step for determining the lateral offset and or orientation of the swap body to the vehicle can take place on the basis of a comparison of the stored reference distances with the actual distances detected by the distance sensors while aligning the vehicle. It is also assumed in the aforementioned embodiments that the distance sensors are laser distance sensors. It is also possible to use other distance sensors, e.g. ultrasonic sensors.

### REFERENCE SYMBOLS

1 vehicle
2 system
3 wheels
4 swap body
41 undersurface
42 guide rail
42.1 inner surface
42.2 outer surface
43 guide rail
43.1 inner surface
43.2 outer surface
44 guide channel
45 leg
46 central plane
47 container
5 driver's cab
8 measurement device
8.1, 8.2, 8.3, 8.4 distance sensors
10.1, 10.2, 10.3, 10.4 measurement beams
M1, M2, M3, M4 measurement points
13 receiving structure
14 signal processing device
15 guide elements/guide rollers
16 movement device
17 height-adjustable chassis
18 longitudinal distance sensor
19 measurement beam
D1, D2, D3, D4 distances
V vertical longitudinal plane
S0, S1, S2, S3, S4 steps of the method

1. A system (2) for determining a lateral offset of a swap body (4) in relation to a vehicle (1) while aligning the vehicle (1) under the swap body (4), characterized by at least two distance sensors (8.1, 8.2, 8.3, 8.4) that can be placed on the vehicle (1), each of which is configured to determine the distance (D1, D2, D3, D4) from the vehicle (1) to predetermined measurement points (M1, M2, M3, M4) on the swap body (4) and output a corresponding signal, wherein each distance sensor (8.1, 8.2, 8.3, 8.4) emits a measurement beam (10.1, 10.2, 10.3, 10.4) for measuring the distance (D1, D2, D3, D4), which is oriented in relation to a vertical longitudinal plane (V) through the vehicle (1) such that it converges on the vertical longitudinal plane starting from the respective distance sensor (8.1, 8.2, 8.3, 8.4), and a signal processing device (14) that is configured to determine a lateral offset of the swap body (4) to the vehicle (1) based on the signals output by the at least two distance sensors (81, 8.2, 8.3, 8.4), and output a corresponding output signal.

2. The system (2) according to claim 1, wherein two of the at least two distance sensors (8.1, 8.2, 8.3, 8.4) are placed at substantially the same longitudinal position in the longitudinal direction of the vehicle (1).

3. The system (2) according to claim 2, wherein two of the at least two distance sensors (8.1, 8.2, 8.3, 8.4) are placed symmetrically in relation to the vertical longitudinal plane (V) through the vehicle (1).

4. The system (2) according to claim 2, wherein the measurement beams (10.1, 10.2, 10.3, 10.4) are oriented such that they pass by or cross one another before reaching the respective measurement points (M1, M2, M3, M4).

5. The system (2) according to claim 2, wherein the measurement beams (10.1, 10.2, 10.3, 10.4) are oriented such that they do not pass by or cross one another before reaching the respective measurement points (M1, M2, M3, M4).

6. The system (2) according to any of the preceding claims, wherein the at least two distance sensors (8, 8.2, 8.3, 8.4) are arranged such that the direction of the measurement beams (10.1, 10.2, 10.3, 10.4) contains a component in the upward vertical direction.

7. The system (2) according to claim 6, wherein at least two of the distance sensors (8.1, 8.2, 8.3, 8.4) are arranged such that the direction of the measurement beams (10.1, 10.2, 10.3, 10.4) contains a component in the longitudinal direction of the vehicle (1) toward the rear.

8. The system (2) according to claim 6, wherein at least two of the distance sensors (8.1, 8.2, 8.3, 8.4) are arranged such that the direction of the measurement beams (10.1, 10.2, 10.3, 10.4) contains a component in the lateral direction of the vehicle (1).

9. The system (2) according to any of the preceding claims, wherein two (8.1, 8.2) of the at least two distance sensors (8.1, 8.2, 8.3, 8.4) are placed toward the rear of the vehicle (1).

10. The system (2) according to any of the preceding claims, wherein two (8.3, 8.4) of the at least two distance sensors (8.1, 8.2, 8.3, 8.4) are placed toward the front of the vehicle (1).

11. The system (2) according to claim 1, wherein two of the at least two distance sensors (8.1, 8.2, 8.3, 8.4) are spaced apart in the longitudinal direction of the vehicle (1), and the system (2) is configured to store reference distances for the respective distance sensors (8.1, 8.2, 8.3, 8.4) based on measured distances (D1, D2, D3, D4) when the swap body (4) is on the vehicle (1) or when the swap body (4) is correctly positioned and oriented over a vehicle (1), and determine a lateral offset of the swap body (4) to the vehicle (1) in a subsequent loading of the swap body (4) based on a comparison of the stored reference distances with the actual distances detected with the distance sensors (8.1, 8.2, 8.3, 8.4), and output a corresponding output signal.

12. The system (2) according to claim 11, wherein the at least two distance sensors (8.1, 8.2, 8.3, 8.4) are placed at the same distance to the vertical longitudinal plane (V) through the vehicle (1).

13. The system (2) according to either of the claim 11 or 12, wherein the at least two distance sensors (8.1, 8.2, 8.3, 8.4) are arranged such that a direction of the measurement beams (10.1, 10.2, 10.3, 10.4) contains a component in the upward vertical direction.

14. The system (2) according to claim 13, wherein at least two of the distance sensors (8.1, 8.2, 8.3, 8.4) are arranged such that the direction of the measurement beams (10.1, 10.2, 10.3, 10.4) contains a component in the longitudinal direction of the vehicle (1) toward the rear.

15. The system (2) according to claim 13 or 14, wherein two of the at least two distance sensors (8.1, 8.2, 8.3, 8.4) are arranged such that the direction of the measurement beams (10.1, 10.2, 10.3, 10.4) contains a component in the lateral direction of the vehicle (1).

16. The system (2) according to any of the preceding claims, wherein the distance sensors (8.1, 8.2, 8.3, 8.4) are laser sensors.

17. The system (2) according to any of the preceding claims, wherein each of the measurement points (M1, M2, M3, M4) is located on a guide assembly on the undersurface (41) of the swap body (4).

18. The system (2) according to claim 17, wherein the guide assembly contains two guide rails (42, 43), wherein the measurement points (M1, M2, M3, M4) are located on an inner surface (42.1, 43.1) of the guide rails (42, 43) or an outer surface (42.2, 42.3) of the guide rails (42, 43).

19. The system (2) according to any of the preceding claims, also comprising a longitudinal distance sensor (18) pointed horizontally toward the rear, which is configured to determine a distance between the vehicle (1) and the swap body (4) in the longitudinal direction of the vehicle (1), wherein the signal processing device (14) is configured to output control signals that assist in the alignment based on the distances measured by the distance sensors and the longitudinal distance sensor (18).

20. A vehicle (1) that has a receiving structure (13) for receiving the swap body (4) and a system (2) according to any of the claims 1 to 18, wherein the distance sensors (8.1, 8.2, 8.3, 8.4) are located on the receiving structure (13).

21. The vehicle (1) according to claim 20, wherein the height of the receiving structure (13) is adjustable.

22. The vehicle (1) according to claim 21, wherein the vehicle (1) contains a control unit for autonomous operation of the vehicle, that enables an autonomous operating mode at least when receiving the swap body (4), wherein the control unit for autonomous operation of the vehicle is sent the output signal from the signal processing device (14).

23. The vehicle (1) according to any of the claims 20 to 22, wherein two (8.1, 8.2) of the at least two distance sensors (8.1, 8.2, 8.3, 8.4) are placed toward the rear of the vehicle (1) seen in the longitudinal direction thereof, and two (8.3, 8.4) of the at least two distance sensors (8.1, 8.2, 8.3, 8.4) are placed toward the front of the vehicle (1), wherein the signal processing device (14) is configured to determine an orientation of the swap body (4) based on the distances detected by both the two distance sensors (8.1, 8.2) in the rear of the vehicle (1) as well as the two distance sensors (8.3, 8.4) toward the front of the vehicle (1).

24. A method for determining a lateral offset of a swap body (4) in relation to a vehicle (1) while aligning the vehicle (1) under the swap body (4) that has a system or a vehicle according to any of the preceding claims, characterized by the steps:
determining (S2) a distance (D1, D2, D3, D4) from the vehicle (1) to predetermined measurement points (M1, M2, M3, M4) on the swap body (4) using at least two distance sensors (8.1, 8.2, 8.3, 8.4) mounted on the vehicle (1), wherein each of the distance sensors (8.1, 8.2, 8.3, 8.4) emit measurement beams (10.1, 10.2 10.3, 10.4) for measuring the distances (D1, D2, D3, D4), which are oriented in relation to a vertical longitudinal plane (V) through the vehicle (1) such that they converge on the vertical longitudinal plane starting from the respective distance sensors (8.1, 8.2, 8.3, 8.4), and
determining (S4) the lateral offset of the swap body (4) to the vehicle (1) based on the signals output by the at least two distance sensors (8.1, 8.2, 8.3, 8.4).

25. The method according to claim 24, also comprising a step (S1) for positioning the at least two distance sensors (8.1, 8.2, 8.3 8.4) such that they are directed at predetermined measurement points (M1, M2, M3, M4) when aligning the vehicle (1), wherein the predetermined measurement points (M1, M2, M3, M4) lie at substantially half the height of the inner surfaces (42.1, 43.1) or the outer surfaces (42.2, 43.2) of the guide rails (42, 43) in the guide channel (44).

26. The method according to either of the claim 24 or 25, wherein at least two of the distance sensors (8.1, 8.2, 8.3, 8.4) are aligned to detect the predetermined measurement points (M1, M2, M3, M4) when the vehicle (1) is located in front of the swap body (4).

27. The method according to any of the claims 24 to 26, also comprising a step (S3) for determining a distance between the vehicle (1) and the swap body (4) in the longitudinal direction of the vehicle (1) with a longitudinal distance sensor (18), wherein the determination (S4) of the lateral offset takes place taking the distance output by the longitudinal distance sensor (18) in to account.

28. The method according to any of the claims 24 to 27, wherein the determination (S4) of the lateral offset takes place using a GPS heading, in order to clear an angular position of the vehicle from the lateral offset.

29. The method according to any of the claims 24 to 28, also comprising a calibration step (S0) for calibrating two distance sensors spaced apart in the longitudinal direction of the vehicle, in which reference distances are stored for the respective distance sensors (8.1, 8.2, 8.3, 8.4) that are based on measured distances to a swap body (4) correctly loaded on the vehicle (1) or a swap body (4) that is correctly positioned and oriented above a vehicle (1).

30. The method according to claim 29, wherein the calibration step takes place automatically when the swap body (4) is loaded correctly or the vehicle (1) is positioned properly underneath it.

31. The method according to claim 29 or 30, wherein the step for determining the lateral offset of the swap body (4) to the vehicle (1) takes place based on a comparison of the stored reference distances with the actual distances detected by the distance sensors (8.1, 8.2, 8.3, 8.4) when aligning the vehicle (1).
